(19) United States
(12) Patent Application Publication
(10) Pub. No.: US 2016/0031185 A1
(43) Pub. Date: Feb. 4, 2016

(54) THIN CONDUCTORS, CONNECTORS, ARTICLES USING SUCH, AND RELATED METHODS

(71) Applicant: CCL LABEL, INC., Framingham, MA (US)

(72) Inventors: Paul Janousek, Simpsonville, SC (US); Alfredo YANES, Fountain Inn, SC (US)

(21) Appl. No.: 14/776,851

(22) PCT Filed: Mar. 12, 2014
(86) PCT No.: PCT/US2014/024078

§ 371 Date: Sep. 15, 2015

Related U.S. Application Data
(60) Provisional application No. 61/786,943, filed on Mar. 15, 2013.

(51) Int. Cl. B32B 7/14; H01M 6/50; G01K 11/12; B32B 38/10; H01R 13/42; B32B 15/20; H01M 10/42

(52) U.S. Cl. CPC B32B 7/14; B32B 15/20; H01M 6/5083; H01M 10/4285; B32B 38/10; H01R 13/42; G01K 11/12; B32B 2307/202; B32B 2457/00; B32B 2457/10

(57) ABSTRACT

Electrically conductive thin metallic films are disclosed. The thin films can be used to form shaped or patterned electrical conductors for consumer goods and electronic applications. Various connectors are also described which can be used in conjunction with the conductors to form thin layered assemblies such as battery testers. Also disclosed are methods for producing the shaped or patterned electrical conductors.

### CROSS REFERENCE TO RELATED APPLICATIONS

The present application claims priority to and the benefit of the filing date of U.S. Provisional Application 61/786,943 entitled “Thin Conductors, Connectors, Articles Using Such, and Related Methods,” filed on Mar. 15, 2013, the entire disclosure of which is incorporated herein by reference.

### FIELD

The present subject matter relates to thin electrically conductive films, connectors for establishing electrical communication to such films, articles using such films and/or connectors, and related methods.

### BACKGROUND

Electrically conductive layers are used in a wide array of consumer products and electronic applications. Such conductive layers are typically provided on a carrier sheet to facilitate handling and/or further processing of the conductive layers(s). In many applications, one or more die cutting operations are used to form shaped patterns from the conductive layers such as electrically conductive strips. Although satisfactory in certain regards, the use of a carrier sheet may be undesirable because after die cutting, the relatively thick carrier sheet may still accompany the electrically conductive shaped pattern. The overall thickness of the shaped pattern and associated carrier sheet may preclude incorporating the assembly in applications in which thinness is a prerequisite. Accordingly, a need exists for a relatively thin conductive layer and related methods of forming particular shapes or patterns of the thin conductive layers.

For certain applications using thin electrically conductive members, the member may exhibit an undesirably high conductivity. Although strategies are known for adjusting the electrical conductivity member and so are costly and may not be appropriate for many applications. Accordingly, a need exists for an economical and convenient method for selectively modifying the electrical conductivity (or its resistivity) of a conductive member.

### SUMMARY

The difficulties and drawbacks associated with previously known components and techniques are addressed in the present thin film members, assemblies, and methods as follows.

In one aspect, the present subject matter provides an electrically conductive thin film including at least one metal selected from the group consisting of copper, gold, silver, aluminum, platinum, nickel, and combinations thereof. The film has a thickness of from 0.05 μm to 3.0 μm.

In another aspect, the present subject matter provides a layered assembly comprising a substrate including a material selected from the group consisting of paper, polymeric resins, silicone release layer, polymer films, and combinations thereof. The layered assembly also comprises an electrically conductive thin film deposited on the substrate or release layer. The thin film includes at least one metal and having a thickness of from 0.05 μm to 3.0 μm.

In yet another aspect, the present subject matter provides a visual indicator of electrical properties. The indicator is in the form of a multilayer assembly comprising an insulator layer and an electrically conductive resistive member disposed on the insulator layer. The indicator also comprises a temperature responsive media layer which undergoes a visible change in response to a change in temperature of the resistive member. And, the indicator also comprises a cover protectively enclosing the assembly. The resistive member is in the form of a thin film having a thickness of from 0.05 μm to 3.0 μm.

In still another aspect, the present subject matter provides a method for forming at least one shaped or patterned region of an electrically conductive thin film. The method comprises forming at least one shaped or patterned region of an adhesive on a substrate. The method also comprises providing a layered assembly including a carrier and a thin layer of an electrically conducting material has a thickness of from 0.05 μm to 3.0 μm. The method also comprises contacting the exposed face of the layer of the electrically conductive material of the layered assembly with the at least one shaped or patterned region of the adhesive. And, the method comprises separating the layered assembly from the at least one shaped or patterned region of the adhesive, whereby a portion of the layer of the electrically conductive material remains in contact with and adhered to the at least one shaped or patterned region of the adhesive.

As will be realized, the subject matter is capable of other and different embodiments and its several details are capable of modifications in various respects, all without departing from the subject matter. Accordingly, the drawings and description are to be regarded as illustrative and not restrictive.

### BRIEF DESCRIPTION OF THE DRAWINGS

FIG. 1 is a schematic planar view of a shaped thin film according to the present subject matter.

FIG. 2 is a schematic planar view of another shaped thin film according to the present subject matter.

FIG. 3 is a schematic planar view of another shaped thin film according to the present subject matter.

FIG. 4 is a schematic cross sectional view of an on-label battery tester in accordance with the present subject matter.

FIG. 5 is a schematic cross sectional view of another on-label battery tester in accordance with the present subject matter.

FIG. 6 is a schematic process diagram illustrating a method for forming thin film components according to the present subject matter.

FIG. 7 is a schematic planar view of a shaped thin film having end regions in communication with electrical connectors in accordance with the present subject matter. connector extending along a face of the thin film.

FIG. 9 is a schematic planar view of another shaped thin film having an electrical connector extending along a face of the thin film.

FIG. 10 is a schematic planar view of yet another shaped thin film having an electrical connector extending along a face of the thin film.

FIG. 11 is a schematic cross sectional view of the thin film and connector of FIG. 8 taken across line 11-11.

FIG. 12 is a schematic cross sectional view of the thin film and connector of FIG. 9 taken across line 12-12.

FIG. 13 is a schematic cross sectional view of the thin film and connector of FIG. 10 taken across line 13-13.

FIG. 14 is a schematic planar view of another shaped film according to the present subject matter.

FIG. 15 is a schematic planar view of another shaped film according to the present subject matter.

### DETAILED DESCRIPTION OF THE EMBODIMENTS

The present subject matter provides thin electrically conductive films or layers, connectors for establishing electrical connectors to such films, articles utilizing such films and/or connectors, and related methods.

### Thin Films

The present subject matter provides thin films, layers and/or patterns of electrically conductive materials. The films typically have a thickness of from about 0.05 μm to about 3.0 μm, in certain versions from 0.1 μm to 1.5 μm, and in particular versions from 0.15 μm to 1.0 μm. In certain of from 0.1 μm to 0.3 μm.

The films can be formed from a wide range of electrically conductive materials such as metals and polymeric materials containing metallic particulates dispersed therein. The metals can include pure or substantially pure metals and/or alloys. Non-limiting examples of metals include copper, gold, silver, aluminum, platinum, nickel, and combinations and alloys thereof. Additional examples of conductive metals include stainless steel, titanium, and palladium.

Depending upon the application, it is contemplated that a wide variety of other suitable conductive materials may be included in the thin film composition, for example an intrinsically conductive polymer such as polyethylenedioxythiophene (PEDOT), polypyrrole (PPy), or polyaniline (PANI); or conductive metal oxide particles. More broadly, a wide range of conductive metal powders or conductive metal compound powders may be utilized as additives.

The electrically conductive thin films can be disposed on and in many instances deposited upon, a wide array of substrates. Non-limiting examples of substrates include paper, polymeric resins, silicone release layers, polymer films, and combinations thereof.

### Forming Patterns of Thin Films

The thin films can be formed using vacuum deposition techniques and more particularly vacuum metallization processes. The techniques also include sputtering methods. These techniques are particularly well suited for forming the relatively thin films. In certain embodiments, the present subject matter also provides techniques for forming patterns or patterned areas of the thin films. For example, the present subject matter also includes directly vacuum depositing a pattern of the thin electrically conductive film on a substrate such as a release coated liner, e.g. polyethylene terephthalate (PET) or paper. Various masking techniques using vacuum deposition can be utilized to create a desired shape or pattern of the thin electrically conducting film. The present subject matter also provides methods for forming patterns of thin films from generally continuous layers or surfaces of such thin films. continuous layer of a thin film is a cold foil process. This process is described in greater detail herein. The present subject matter also includes other techniques. A cold foil process typically employs a standard polymer flexo plate. An image is printed onto a substrate with the use of a UV-curable adhesive. A UV dryer then activates the adhesive. The extracted foil is affixed to the printed adhesive and an image is created. There are generally two types of processes of cold foil printing available—wet or dry lamination. Each process uses a specially formulated adhesive that is not interchangeable with the other. In certain versions, the present subject matter uses a process that has been designed for use on a flexographic press. However, the same principles can be applied to a letterpress.

For dry lamination, certain adhesives such as cationic adhesives, Magna-Cryl 4505, 4503 or 4512 can be used. These adhesives are commercially available from Beacon Adhesives. Using a photo polymer plate, an image is printed onto a substrate from a standard flexo station. The UV dryer activates the adhesive which renders the adhesive tacky. The foil is then nipped onto the substrate with a nip roll or a spare anvil in a die station, and then is immediately pulled away to the waste wind up. The extracted foil is affixed to the printed adhesive and an image is created.

For wet lamination, certain adhesives such as a free radical adhesive, Magna-Cry 4520 can be used. That adhesive is available from Beacon Adhesive. Using a photo polymer plate, an image is printed onto a substrate from a standard flexo print station. The foil is then laminated onto the substrate, which is then passed under a UV lamp station. The printed adhesive is cured, thereby bonding the foil onto the substrate. The foil is then stripped and wound to a waste wind-up.

Using a cold foil process provides various advantages such as, but not limited to, fast set up, no requirement for upfront tooling or dies, relatively fast speeds, ability to be used in association with a variety of substrates such as films and non-absorbent papers, fast turnaround, efficient for both short and long print runs, better registration performance than hot stamping methods, and can be readily implemented.

In contrast to typical hot stamping processes, a cold foil process does not require elevated temperatures. Generally, the pressure sensitive adhesive contacts and adheres to the thin metal film coated surface. A wide array of pressure sensitive adhesives can be used. However, UV-based pressure sensitive adhesives have been found to be useful. A UV based pressure sensitive adhesive can be cured in contact with the thin metal film and then removed. Alternatively, the UV based pressure sensitive adhesive can be cured first, adhered or laminated to the thin metal film, and then removed. The cold foil process can be performed at room temperatures, e.g. 18-22° C., and does not require conventional heated brass dies used in hot stamping techniques that can deform the thin electrically conductive film. Additional details and aspects of cold foil printing are provided in one or more of the following US patents: U.S. Pat. Nos. 6,153,278; 8,316,764; 4,484,970; 4,994,131; and 4,868,049.

### Articles Utilizing Thin Films

The present subject matter also provides a wide array of articles using the thin films as described herein. A particular embodiment of such an article is a visual indicator of electrical properties. An example of such an indicator is an on-label battery tester. The term “on-label” refers to the battery tester being incorporated within a label or component of a label assembly that is applied to a battery such as a dry cell low voltage battery. Examples of such batteries include but are not limited to batteries having designations such as “A”, “AA”, “AAA”, “C”, “9-volt”, and “D” batteries.

The on-label battery tester of the present subject matter utilizes one or more shaped regions of the thin films. In certain versions, the thin films have a thickness of from 0.1 μm to 0.3 μm. Typically, the shaped regions of thin films are formed from copper. Generally, on-label battery testers are in the form of a multilayer assembly comprising (i) an insulator layer or substrate, (ii) an electrically conductive resistive element or member, (iii) a thermochromic or other temperature responsive media layer, and (iv) a cover or suitable protective outer layer. A user establishes electrical contact between the two poles of the battery to thereby cause electrical current from the battery to pass through the resistive element. Selective electrical contact can be provided by incorporation of electrical switches such as membrane switches, in the on-label battery tester. Current flow through the resistive element produces heat which is transmitted to the thermochromic layer. That layer contains an amount of one increases. The visible change is viewable through the cover or protective layer. Details and other aspects of on-label battery testers are provided in one or more of the following patents: U.S. Pat. Nos. 5,223,003; 5,830,596; 6,054,234; 5,925,480; 6,048,572; 5,709,962; and 5,627,472.

### Connectors

The present subject matter also provides electrically conductive compositions and connecting elements or pads which provide electrical connection to the thin film components. In certain embodiments, the connectors can also be formed and/or tailored to selectively adjust the overall electrical resistance of the shaped articles of the thin films. In addition, in certain versions of the subject matter, the connectors are formulated to reduce oxidation and/or increase resistance to potassium hydroxide such as at the contact points for activation of an on-cell battery tester for example. Incorporating nickel, or in certain applications increasing the proportion of nickel, in the connectors has been found to increase resistance to potassium hydroxide.

In one version of the present subject matter, the connectors are disposed or formed upon ends or regions of the thin films. And, in other versions, the connectors are disposed or formed upon the entirety or substantial entirety of the thin film or thin film component.

Generally, the composition used to form the connectors includes electrically conductive particles dispersed in a suitable binder such as a UV curable acrylate with optional amounts of solvent. The particles are typically silver coated copper particles, silver particles, nickel particles, carbon particles, copper particles, and combinations thereof. However, it will be appreciated that the present subject matter includes the use of other particles, components, and/or additives. An example of suitable carbon particles is electrically conductive carbon black particles.

Many of the compositions described herein for forming electrically conductive connectors utilize particles such as metallic particles dispersed in the compositions. The particles can be in a wide range of sizes and can be provided in particular size distributions or populations of sizes. Non-limiting size ranges for the particles can range from 0.1 μm to 35 μm, more particularly from 1.0 μm to 20 μm, includes the use of particles having a size smaller than 0.1 μm and in certain applications, greater than 35 μm. The particles can be any shape depending upon the application. Non-limiting examples include spherical and flake. Additional details of the compositions are provided herein.

The present subject matter provides particular compositions for forming the noted connectors. Several representative compositions are provided and designated herein as (i) silver coated copper, (ii) silver, (iii) nickel, and (iv) nickel carbon. These compositions are set forth in Tables 1-4:

TABLE 1
Silver Coated Copper Composition

| | Typical | Particular |
|---|---|---|
| Component | Percentage(s) | Percentage(s) |
| Silver Coated | 65%-85% | 75% |
| Copper Particles | | |
| UV Curable Acrylate | 15%-35% | 25% |

TABLE 2
Silver Composition

| | Typical | Particular |
|---|---|---|
| Component | Percentage(s) | Percentage(s) |
| Silver Particles | 35%-75% | 41%-56% |
| Binder | 5%-20% | 10%-15% |
| Water or Solvent | 20%-40% | 34% |

TABLE 3
Nickel Composition

| | Typical | Particular |
|---|---|---|
| Component | Percentage(s) | Percentage(s) |
| Nickel Particles | >50% | 50%-60% |
| Acrylic | 5%-20% | 5%-10% |
| Solvent | 10%-45% | 20%-40% |

TABLE 4
Nickel Carbon Composition

| | | |
|---|---|---|
| Nickel Particles | 40%-60% | 50%-55% |
| Carbon Particles | 5%-20% | 10%-15% |
| Solvent | 10-55% | 20%-40% |
| Acrylic | 5-20% | 5%-10% |

In certain versions of the present subject matter, it may also be possible to use commercially available electrically conductive inks such as those available from Henkel Electronic Materials, Engineered Conductive Materials (ECM), and Conductive Compounds Inc.

The electrically conductive compositions used for forming the connectors can be aqueous based, solvent based, or UV curable. The compositions may include any of the electrically conductive polymers, additives, or other components noted for use in the thin films.

Once prepared such as by conventional blending techniques or otherwise obtained, are applied by deposition on one or more regions of a thin film as described herein. After deposition, the compositions are appropriately dried and/or cured to form an electrically conductive connector which is in electrical communication with the thin film. The connector can be disposed on and/or under the thin film. In certain applications it may be desirable to first form one or more connectors and then form one or more thin films thereon. Other assembly techniques are contemplated such as formation of connector(s) on substrates, formation of thin films on other or the same substrate, and then mating of the components to thereby form an electrically conductive pattern or circuit.

The electrical connectors are typically disposed at opposite ends of a thin film strip or longitudinal member as described herein. In certain applications, the electrical connectors also are disposed on intermediate regions extending between ends of a thin film strip. By appropriate selection of the size, shape, and placement of the connector(s) placed in electrical communication with the thin film strip(s), one can selectively achieve or modify the electrical conductivity of the resulting combination of thin film and connector(s).

The present subject matter also provides one or more coatings or layers applied to surfaces or regions of the conductive thin strips or to exposed surfaces of the connectors to protect those surfaces or regions. For example, protection from oxidation and/or corrosion can be provided by depositing a layer or coating of an Organic Solder Protectant (OSP) or poly(methyl methacrylate). OSP's are also known in the art as Organic Solderability Preservatives. Non-limiting examples of OSP's include alkyl benzimidazoles and aryl phenylimidazoles. Additional examples and details concerning OSP's are provided in U.S. Pat. No. 5,795,409.

In many applications, the composition of the electrically conductive connectors or material thereof is different than the composition of the thin films. Furthermore, in many applications, the electrical conductivity of the connectors is different than the electrical conductivity of the thin films. In particular embodiments of the present subject matter, the electrical conductivity of the connectors is less than that of the thin films.

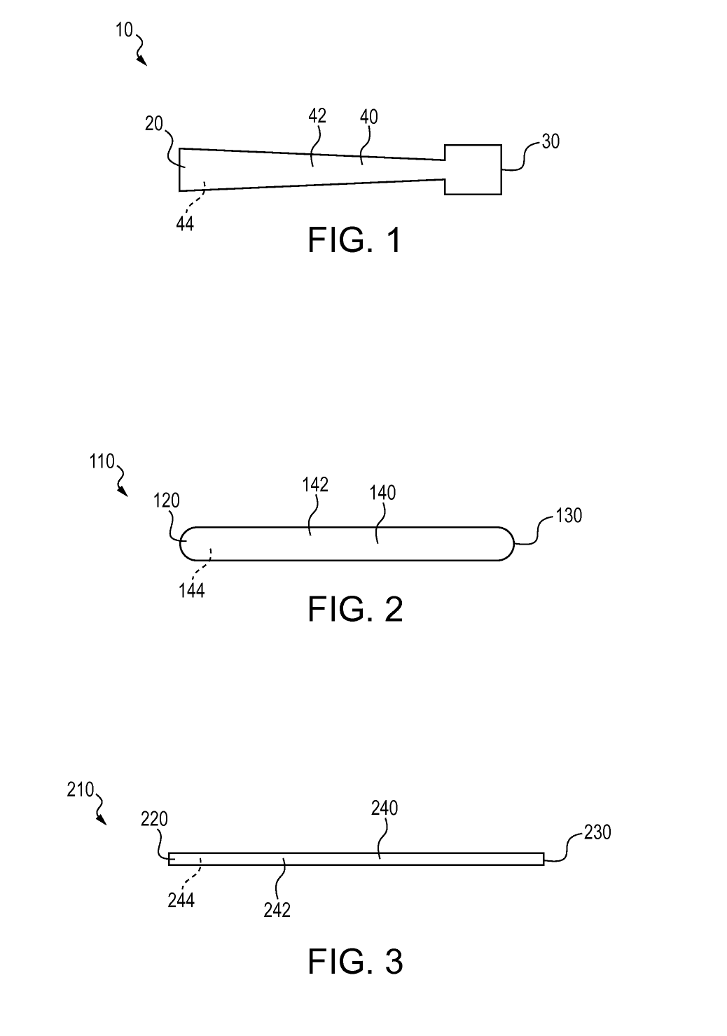

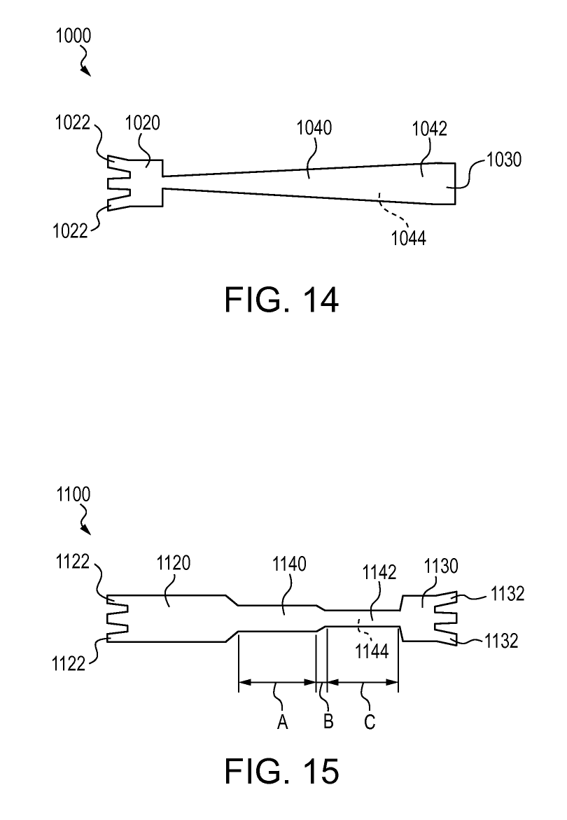

FIGS. 1-3 schematically illustrate in planar view, several representative embodiments of shaped electrically conductive thin films in accordance with the present subject matter. FIG. 1 depicts an electrically conductive film 10 having a first end 20, a second end 30 opposite from the first end, and a span 40 extending between the ends 20 and 30. The film 10 also defines a first face 42 and an oppositely directed second face 44. The film 10 may have a variety of different shapes and configurations. For example, in FIG. 1, the span 40 is shown as having edges that converge toward one another from the first end 20 to the second end 30. In addition, the film 10 may also include end regions having expanded surface areas such as that shown in FIG. 1 adjacent the second end 30. Second end 30 can also include fingers, which aid in shrinkage of the film to make contact with the cell. Such fingers are described in greater detail herein in conjunction with FIGS. 14 and 15.

FIG. 2 depicts another shaped film 110 having first and second ends 120, 130 respectively, a span 140 extending therebetween, and first and second faces 142, 144, respectively. In this version, the span edges extend parallel to one another, and the end edge regions are rounded. respectively, a span 240 extending therebetween, and first and second faces 242, 244, respectively. In this version of the present subject matter, the edges of the span 240 extend parallel to one another and extend to square corners at the ends 220, 230. The shaped films 10, 110, and 210 are relatively thin and feature a thickness as described herein.

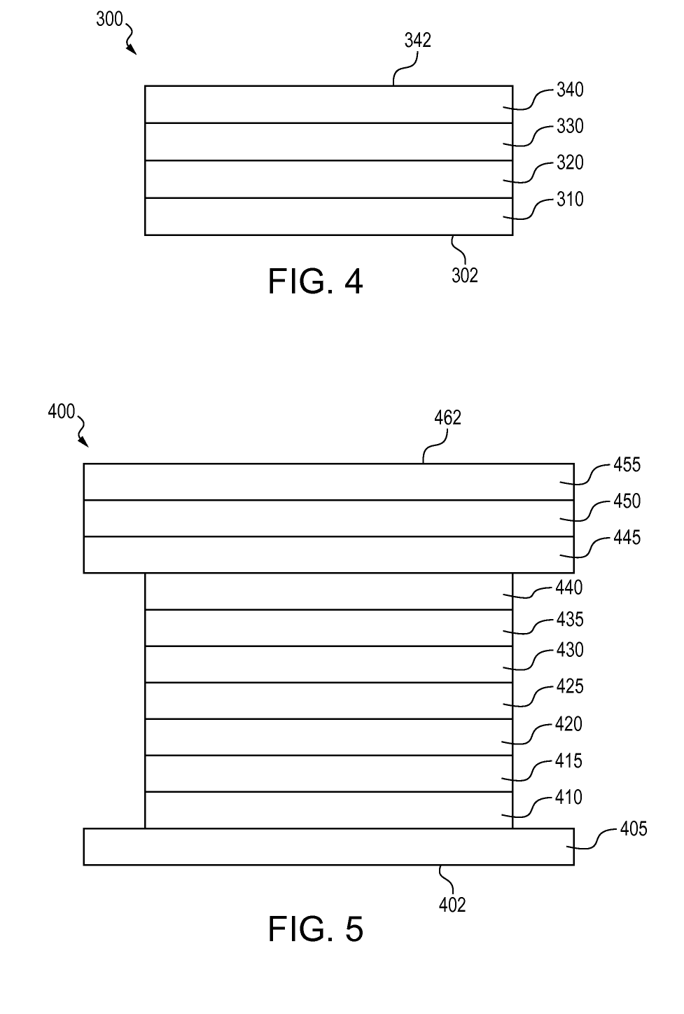

FIG. 4 is a schematic cross sectional view of an on-cell battery tester label assembly utilizing a shaped film in accordance with the present subject matter. The label assembly 300 comprises an insulator layer or substrate 310, an electrically conductive shaped film 320, a temperature responsive indicator 330, and a cover or protective layer 340. The label assembly 300 also defines an inner face 302 and an oppositely directed outer face 342. The insulator layer is typically an electrical insulator and can be formed from paper, polymeric resins, or combinations thereof. The label assembly 300 can be incorporated in a battery label which is then applied to a battery, or applied directly to a battery (labeled or prelabeled). Upon application, the inner face 302 is directed toward the battery. The shaped film 320 is relatively thin and has a thickness as described herein. In certain embodiments, the thickness of the shaped film is in a range of 0.1 μm to 0.3 μm. It will be appreciated that the label assembly 300 can include additional layers, components, and materials.

FIG. 5 is a schematic cross sectional view of another on-cell battery tester label in accordance with the present subject matter. The label assembly 400 comprises a liner layer 405. The liner 405 can be in the form of a siliconized polymeric film such as for example a siliconized polyethylene terephthalate (PET) layer. A typical thickness for the liner layer 405 is 10 μm to 40 μm and more particularly 13 μm to 38 μm. The label assembly 400 also comprises an insulator layer 410. A representative material for this layer is Natural Kraft Insulator Paper Punched. A typical thickness for this layer is from 100 μm to 200 μm and more particularly 127 μm to 180 μm. The label assembly 400 also comprises an adhesive layer 415. In the embodiment of FIG. 5, the adhesive layer 415 is a pressure sensitive adhesive, transparent or substantially so, and UV curable. A typical thickness for the pressure sensitive adhesive layer 415 is 5 μm. The label assembly 400 also comprises a dielectric layer 420. The dielectric layer 420 can be colored such as to exhibit a red (or other) color. The dielectric layer dielectric layer 420 is 10 μm. The layer assembly 400 also comprise a thin metallic carrier or release 425 such as an aluminum layer having a thickness less than about 0.1 μm. The label assembly 400 also comprises a thin electrically conductive film 430 as described herein. The thin electrically conductive film 430 can include an array of metals and other electrically conductive compositions. In the embodiment of FIG. 5, the film 430 includes metallized copper having a thickness in a range of 0.1 μm to 0.3 μm. The label assembly 400 also comprises another colored polymeric resin layer 435. The layer 435 typically exhibits a color different than that of layer 420, such as yellow. The layer 435 is generally formed from a polymeric resin and is UV curable. The label assembly 400 also comprises a layer of a temperature responsive material 440, such as for example a thermochromic ink. The layer 440 can be UV curable, and typically has a thickness of from 20 μm to 50 μm and more particularly from 25 μm to 38 μm. The label assembly 400 also comprises an adhesive layer 445. A representative adhesive is an emulsion adhesive applied at coatweight of 20 gsm. A commercially available adhesive designated as AE 3506 from Avery Dennison can be used. The label assembly 400 can also include a graphics layer 450 which can include colors, designs, indicia, and/or text. The label assembly 400 also comprises a polymeric film 455 which generally protects the assembly. Typically, the film 455 is transparent or substantially so. The film can be formed from various materials such as but not limited to polyethylene terephthalate glycol-modified, polyvinyl chloride, and the like. Typical thicknesses for the layer 455 are from 30 μm to 80 μm and more particularly from 37 μm to 69 μm.

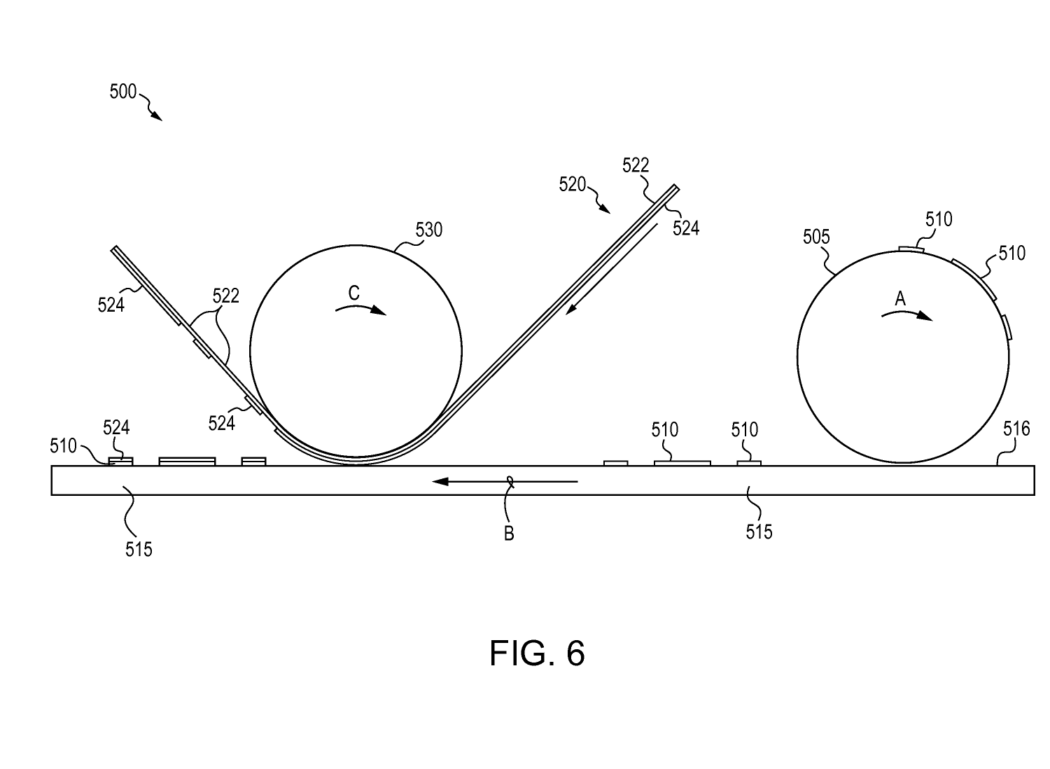

FIG. 6 is a schematic process diagram of a cold foil process in accordance with the present subject matter for forming shaped thin films. It is also contemplated that this process could be used for forming connectors as described herein. The process 500 comprises an operation in which a cylinder 505 or other rotary applicator carrying adhesive regions 510 along its circumference, portions thereof, or outer surface, is positioned in engagement with a linearly moving substrate 515 having a receiving face 516. As shown in FIG. 6, the cylinder 505 and the substrate 515 are positioned and undergo displacement such that as the cylinder 505 rotates in direction A, regions of adhesive 510 are 515.

The process 500 also comprises an operation in which a layered assembly 520 including a carrier film 522 and a foil or metallized layer 524 are directed to a rotary member 530. The metallized layer 524 is relatively thin, e.g. from 0.05 μm to 3.0 μm. The cylinder or rotary member 530, rotating in direction C as shown in FIG. 6, directs the layered assembly 520 and specifically, an exposed face of the foil layer 524 of the layered assembly 520 along the receiving face 516 of the linearly moving substrate 515. Contact occurs between the foil layer 524 and any adhesive regions 510 on the substrate 515. Such contact causes removal of regions of the foil layer 524 of the layered assembly 520 on the rotary member 530, to the adhesive regions 510 on the substrate 515. Thus, as shown in FIG. 6 downstream of the rotary member 530, layered regions of adhesive 510 and foil 524 are disposed on the moving substrate 515. After leaving the rotary member 530, the layered assembly 520 containing the carrier film 522 and remnants of the foil layer 524 is directed to recovery, recycling, or other operation(s). The layered regions of adhesive 510 and foil 524 on the substrate 515 are transferred from the process 500 to other operations as desired, or to storage. The foil layer 524 disposed on the adhesive regions 510 is relatively thin, i.e. from 0.05 μm to 3.0 μm, and can be used in a wide array of applications and particularly those in which one or more thin, electrically conductive components are needed.

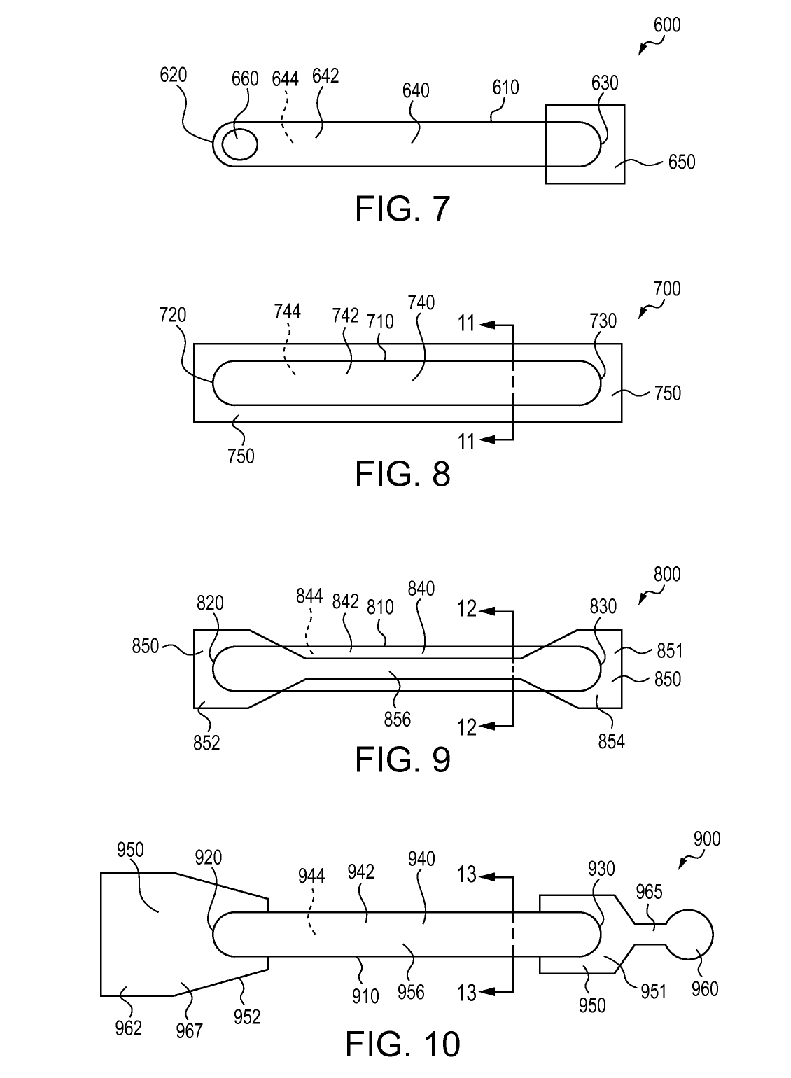

FIGS. 7-13 schematically depict various shaped thin films having one or more regions, areas, or portions in electrical communication with one or more electrical connectors in accordance with the present subject matter. As described herein, the electrical conductivity of the connector(s) is different than that of the thin film. And thus, by selection of the arrangement, positioning, and/or relative sizes, of the thin film and the connector(s) and configuration of the resulting assembly, one can selectively adjust the overall resistivity of the combination of thin film and connector(s).

Specifically, FIG. 7 illustrates a layered assembly 600 comprising a shaped thin film 610 having first and second end, 620, 630, respectively, a span 640 extending therebetween, and first and second faces 642, 644, respectively. Disposed at one end such as end 620, is a region 660 of an 610. The region 660 is in electrical communication with the thin film 610. The region 650 extends along and is in electrical communication with the thin film 610. The region 650 is in contact with one or both of the faces 642 and 644 of the thin film 610. Each of the regions 650 and 660 can be provided in a variety of shapes and sizes. Moreover, the regions 650 and 660 can be shaped and/or sized differently from one another or they can be the same size and/or shape. In addition, the regions 650 and 660 can be compositionally the same or different from one another. The regions 650 and 660 can be formed from any of the materials described herein such as those set forth in Tables 1-5.

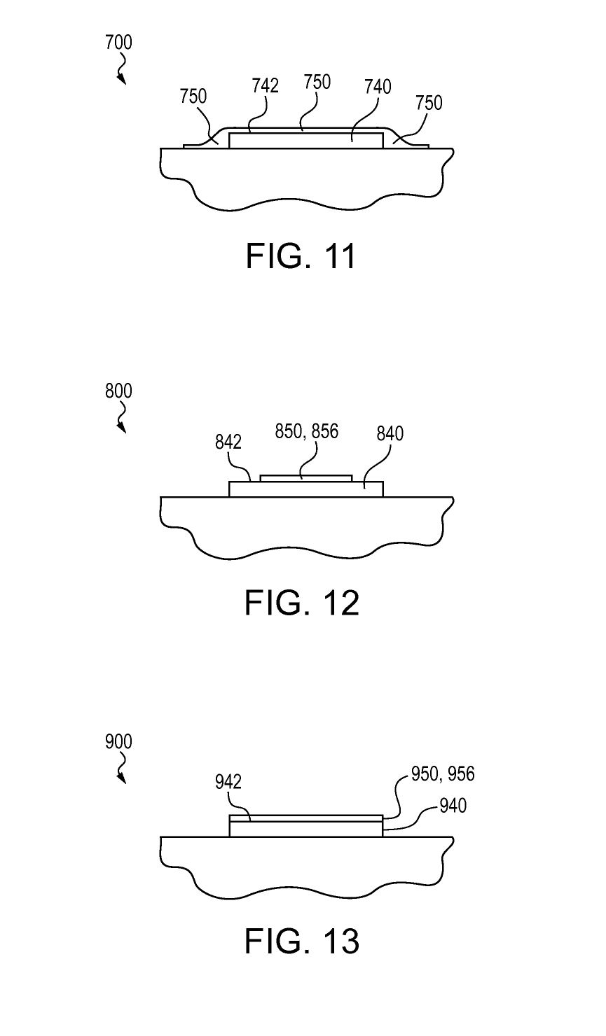

FIG. 8 illustrates another layered assembly 700 comprising a shaped thin film 710 having first and second ends, 720, 730, respectively, a span 740 extending therebetween, and first and second faces 742, 744 respectively. Disposed at one or both ends such as end 720 and/or 730 is a region 750 of an electrical connector as described herein. The region 750 extends along and is in electrical communication with the thin film 610. The region 750 is in contact with one or both of the faces 742 and 744 of the thin film 710. The region 750 can be provided in a variety of different shapes and sizes. In the particular embodiment shown, the region 750 is a generally continuous layer deposited under or over the thin film 710. For deposition of the region 750 upon the thin film 710, FIG. 11 illustrates a schematic cross sectional view of the assembly 700 taken across line 11-11 in FIG. 8.

FIG. 9 illustrates a layered assembly 800 comprising a shaped thin film 810 having first and second ends 820, 830 respectively, a span 840 extending therebetween, and first and second faces 842, 844 respectively. The layered assembly 800 also comprises an electrical connector 850 having ends 851 and 852, and a span 856 extending therebetween. The connector 850 is in electrical communication with at least one of the ends 820, 830 of the thin film 810, and in certain versions, in contact with one or both faces 842, 844 of the thin film 810. The connector 850 may be provided in a wide array of different shapes and sizes relative to the thin film 810. In the particular embodiment shown, the connector 850 is disposed on the face 842 of the thin film 840 as depicted in FIG. 12. In the version of the connector 850 shown in FIG. 9, the ends 851 and 852 of the connector 850 are enlarged or at least have a surface area greater than corresponding end regions of the thin film, such as thin film 810. Referring further to FIG. 12, it can be seen that the width of the connector 850 is less than the width of the span 840 of the thin film 810. The present subject matter includes a wide array of different arrangements, orientations, and configurations of components.

FIG. 10 is a planar schematic view of another layered assembly 900 in accordance with the present subject matter. The assembly 900 comprises a thin film 910 having opposite ends 920, 930 and a span 940 extending therebetween. The thin film 910 also defines oppositely directed faces 942 and 942. The layered assembly 900 also comprises an electrical connector 950 having ends 951, 952, and a span 956 extending therebetween. The connector 950 also includes enlarged end regions 960, 962 for facilitating electrical connection to the thin film 910. The end region 960 is in communication with the end 951 via a bridge 965. And, the end region 962 is in communication with the end 952 via a region 967. The connector 910 is in contact with the face 942 of the thin film as shown in FIG. 13. The width of the connector 950 along the region of the span 940 is the same or substantially the same as the width of the span 940. However, it will be appreciated that the present subject matter includes a range of alternate configurations.

FIGS. 14 and 15 illustrate in schematic view, additional representative embodiments of shaped electrically conductive thin films in accordance with the present subject matter. FIG. 14 depicts an electrically conductive film 1000 having a first end 1020, a second end 1030 opposite from the first end, and a span 1040 generally extending between the ends 1020 and 1030. The film 1000 also defines a first face 1042 and an oppositely directed second face 1044. The film 1000 also exhibits a width that generally uniformly varies across at least a portion of the length of the film. The reference to length of the film 1000 being with regard to the dimension between the ends 1020 and 1030. The film 1000 also includes one or more projections 1022 or “fingers” that extend from the end 1020. A wide array of shapes, sizes, and orientations may be used for the fingers 1022. The fingers may number from one or two up to several such as three which are depicted in the referenced figures. The fingers may number four or more in certain versions of the present subject matter. end 1130 opposite from the first end, and a span 1140 generally extending between the ends 1130 and 1140. The film 1100 also defines a first face 1142 and an oppositely directed second face 1144. The film 1100 also exhibits a width that varies across a length dimension in a stepwise fashion. Thus, in the particular embodiment depicted in FIG. 15, the width of the film 1100 in a first region shown as region A is greater than the width in a second region shown as region C. The width of the film 1100 in each of the regions A and C remains constant. The film 1100 can also include a width transition region such as region B in which the width of the film 1100 varies in a lengthwise dimension between the regions A and C. Alternatively, the width transition region B could be eliminated. The film 1100 also includes fingers disposed on each of the ends of the film. Thus, the film 1100 includes a plurality of fingers 1122 extending from the end 1120 and a plurality of fingers 1132 extending from the end 1130. It will be understood that the present subject matter includes a wide array of shapes and configurations for films, and in no way is limited to the particular versions described herein and illustrated in the referenced figures.

The present subject matter will find wide application in various fields. For example, the present subject matter is applicable to incorporating electrically conductive circuits or components in on-cell battery labels, consumer articles, clothing, portable electronic devices, security and monitoring applications, retail merchandise and inventory applications, medical articles including sheet based bands and tagging devices, automotive applications, and any application in which a relatively thin electrically conductive element is utilized.

Many other benefits will no doubt become apparent from future application and development of this technology.

All patents, applications, and articles noted herein are hereby incorporated by reference in their entirety.

As described hereinabove, the present subject matter solves many problems associated with previous strategies, systems or devices. However, it will be appreciated that various changes in the details, materials and arrangements of components and operations, which have been herein described art without departing from the principle and scope of the subject matter, as expressed in the appended claims.

1. An electrically conductive thin film including at least one metal selected from the group consisting of copper, gold, silver, aluminum, platinum, nickel, and combinations thereof, wherein the film has a thickness of from 0.05 μm to 3.0 μm.

2. The thin film of claim 1 wherein the film has a thickness of from 0.1 μm to 1.5 μm.

3. The thin film of claim 2 wherein the film has a thickness of 0.15 μm to 1.0 μm.

4. The thin film of claim 1 wherein the thin film includes copper.

5. The thin film of claim 1 further comprising:
a layer of an Organic Solderability Preservative (OSP) disposed on at least a portion of the thin film.

6. The thin film of claim 1 further comprising:
a layer of poly(methyl methacrylate) (PMMA) disposed on at least a portion of the thin film.

7. The thin film of claim 1 wherein the thin film further includes at least one conductive polymer.

8. A layered assembly comprising:
a substrate including a material selected from the group consisting of paper, polymeric resins, silicone release layer, polymer films, and combinations thereof;
an electrically conductive thin film disposed on the substrate, the thin film including at least one metal and having a thickness of from 0.05 μm to 3.0 μm.

9. The layered assembly of claim 8 wherein the thin film has a thickness of from 0.1 μm to 1.5 μm.

10. The layered assembly of claim 9 wherein the thin film has a thickness of from 0.15 μm to 1.0 μm.

11. The layered assembly of claim 8 wherein the thin film includes copper.

12. The layered assembly of claim 8 wherein the substrate includes paper.

13. The layered assembly claim 8 wherein the substrate includes at least one polymeric resin.

14. The layered assembly of claim 8 further comprising:
a layer of an Organic Solderability Preservative (OSP) disposed on at least a portion
of the thin
film.

15. The layered assembly of claim 8 further comprising:
a layer of poly(methyl methacrylate) (PMMA) disposed on at least a portion of the thin film.

16. The layered assembly of claim 8 wherein the thin film further includes at least one conductive polymer.

17. The layered assembly of claim 8 further comprising:
at least one electrical connector in electrical communication with the electrically conductive thin film, wherein the electrical connector has a composition different than the composition of the thin film.

18. The layered assembly of claim 17 wherein the electrical conductivity of the composition of the electrical connector is different than the electrical conductivity of the composition of the thin film.

19. The layered assembly of claim 18 wherein the electrical conductivity of the composition of the electrical connector is less than the electrical conductivity of the composition of the thin film.

20. The layered assembly of claim 17 wherein the thin film defines a first end, a second end, and a span extending between the first end and the second end, and the electrical connector is disposed on at least one of the first end and second end of the thin film.

21. The layered assembly of claim 20 wherein the electrical connector is disposed on both the first end and the second end of the thin film.

22. The layered assembly of claim 20, wherein the electrical connector is disposed on the span of the thin film.

23. The layered assembly claim 17 wherein the electrical connector includes particles selected from the group consisting of (i) silver coated copper particles, (ii) silver particles, (iii) nickel particles, (iv) carbon particles (v) copper particles, and combinations thereof.

24. A visual indicator of electrical properties, the indicator being in the form of a multilayer assembly comprising:
an insulator layer;
an electrically conductive resistive member disposed on the insulator layer;
a temperature responsive media layer which undergoes a visible change in response to a change in temperature of the resistive member; and
a cover protectively enclosing the assembly;
wherein the resistive member is in the form of a thin film having a thickness of from 0.05 μm to 3.0 μm.

25. The indicator of claim 24 wherein the resistive member includes at least one metal selected from the group consisting of copper, gold, silver, aluminum, platinum, nickel, and combinations thereof.

26. The indicator of claim 24 wherein the temperature responsive media layer includes thermochromic ink.

27. The indicator of claim 24 wherein the film has a thickness of from 0.1 μm to 1.5 μm.

28. The indicator of claim 27 wherein the film has a thickness of 0.15 μm to 1.0 μm.

29. The indicator of claim 24 wherein the thin film includes copper.

30. The indicator of claim 24 further comprising:
a layer of an Organic Solderability Preservative (OSP) disposed on at least a portion of the thin film.

31. The indicator of claim 24 further comprising:
a layer of poly(methyl methacrylate) (PMMA) disposed on at least a portion of the thin film.

32. The indicator of claim 24 wherein the thin film further includes at least one conductive polymer.

33. A method for forming at least one shaped or patterned region of an electrically conductive thin film; the method comprising:
forming at least one shaped or patterned region of an adhesive on a substrate;
providing a layered assembly including a carrier and a thin layer of an electrically conducting material disposed on the carrier, the layer of the electrically conducting material defining an exposed face and having a thickness of from 0.05 μm to 3.0 μm;
contacting the exposed face of the layer of the electrically conductive material of the layered assembly with the at least one shaped or patterned region of the adhesive;
separating the layered assembly from the at least one shaped or patterned region of the adhesive, whereby a portion of the layer of the electrically conductive material remains in contact with and adhered to the at least one shaped or patterned region of the adhesive.

34. The method of claim 33 wherein forming the at least one shaped or patterned region of the adhesive on a substrate is performed by printing the adhesive on the substrate using a rotary member.

35. The method of claim 33 wherein contacting the exposed face of the electrically conductive material of the layered assembly with the at least one shaped or patterned region of the adhesive is performed by directing the face of the layered assembly to thereby contact the adhesive regions using a rotary member.

36. The method of claim 33 wherein as a result of separating the layered assembly from the at least one shaped or patterned region of the adhesive, a remnant of the electrically conductive material is obtained, the method further comprising:
collecting the remnant of the electrically conductive material.

37. A region of an electrically conductive thin film produced by the method of claim 33.
